(19) United States
(12) Patent Application Publication
(10) Pub. No.: US 2023/0405848 A1
(43) Pub. Date: Dec. 21, 2023

(54) WORK SYSTEM

(71) Applicant: CONNECTED ROBOTICS, INC., Tokyo (JP)

(72) Inventors: Hidenao ISHIKAWA, Tokyo (JP); Satoru AMATSU, Tokyo (JP); Keita MINOWA, Tokyo (JP)

(73) Assignee: CONNECTED ROBOTICS, INC., Tokyo (JP)

(21) Appl. No.: 18/210,029

(22) Filed: Jun. 14, 2023

(30) Foreign Application Priority Data
Jun. 20, 2022 (JP) 2022-099254

(51) Int. Cl. B25J 19/00; B25J 11/00

(52) U.S. Cl. CPC B25J 19/0075; B25J 11/008

(57) ABSTRACT

A heating cooking system includes heat-shielding plates that are, with respect to a heat-vulnerable portion of a multi-joint robot that performs work, installed on a structure (a wall or a device or the like that is fixed) other than the multi-joint robot, and protect the heat-vulnerable portion of the multi-joint robot from heat generated by a heat source. The heat-shielding plates are also installed at positions and forms whereby conveyance of heat to the heat-vulnerable portion is suppressed, while not interfering with the multi-joint robot when the multi-joint robot operates.

### CROSS-REFERENCE TO RELATED APPLICATIONS

This application is based upon and claims the benefit of priority under 35 USC 119 of Japanese Patent Application No. 2022-99254 filed on Jun. 20, 2022 the entire disclosure of which, including the description, claims, drawings, and abstract, is incorporated herein by reference in its entirety.

### BACKGROUND OF THE INVENTION

### Field of the Invention

The present invention relates to a work system.

### Description of the Related Art

In recent years, robots have come to be used in various types of work in facilities in which cooking is performed, such as in kitchens in shops, food trucks, and so forth.

For example, in a kitchen where deep-frying cooking is performed, work is performed in which a robot for cooking places foodstuff in a reservoir vat of heated cooking oil, retrieves the foodstuff after a certain amount of time has elapsed, and so forth.

Having robots perform work enables frequency of humans being involved in dangerous work to be reduced, and robots to handle work that is physically demanding in high-temperature environments, and accordingly the usage value of robots is becoming extremely high in sites where work such as cooking and so forth is performed.

### BRIEF SUMMARY OF THE INVENTION

A work system according to an aspect of the present invention comprising:
a robot that performs work;
a facility used for the work; and
a heat-shielding member that is installed on a structure other than the robot, and is disposed between a portion that is a heat source in an operating range of the robot in the facility, and a position of a heat-vulnerable portion in the robot that is an object part of heat-proofing measures.

### BRIEF DESCRIPTION OF THE SEVERAL VIEWS OF THE DRAWING

FIG. 1 is a schematic diagram (a schematic diagram illustrating an overall configuration of the heating cooking system 1) illustrating a configuration of a heating cooking system 1 according to the present invention.

FIG. 2 is a schematic diagram (a perspective view of a heating cooker 10 from the front) illustrating a configuration of a heating cooking system 1 according to the present invention.

FIG. 3 is a schematic diagram illustrating a configuration example of the heat-shielding plates 12 and 13 installed in the heating cookers 10A and 10B.

FIG. 4 is a schematic diagram illustrating heat-shielding operations of the heat-shielding plates 12 and 13.

FIG. 5 is a schematic diagram illustrating a configuration of principal portions of the foodstuff supply device 100.

FIG. 6 is a schematic diagram illustrating a hardware configuration of the control device 70.

FIG. 7 is a block diagram illustrating the functional configuration of the control device 70.

FIG. 8 is a flowchart illustrating the flow of heating-cooking processing executed by the heating cooking system 1.

FIGS. 9A to 9C are schematic views illustrating specific configuration examples of the heat-shielding plate 12.

### DETAILED DESCRIPTION OF THE INVENTION

Embodiments of the present invention will be described below with reference to the drawings.

### First Embodiment

### [Configuration]

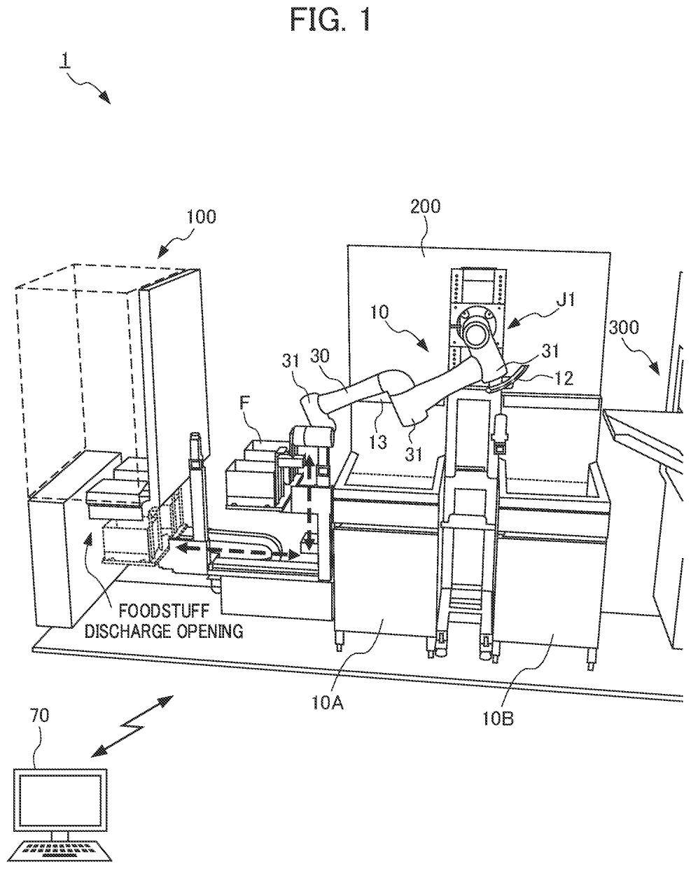

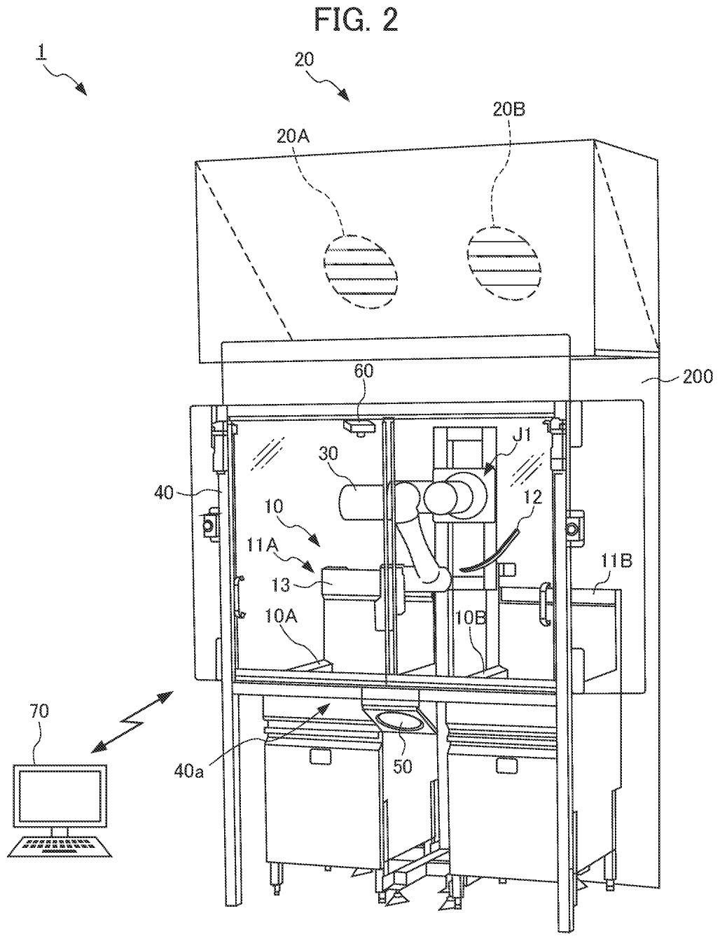

FIGS. 1 and 2 are schematic diagrams illustrating a configuration of a heating cooking system 1 according to the present invention, in which FIG. 1 is a schematic diagram illustrating an overall configuration of the heating cooking system 1, and FIG. 2 is a perspective view of a heating cooker 10 from the front.

As illustrated in FIGS. 1 and 2, the heating cooking system 1 includes the heating cooker 10, an exhaust fan 20, a multi-joint robot 30, a safety window 40, a blower fan 50, an imaging device 60, and a control device 70. Also, in a case in which the heating cooking system 1 is installed, a foodstuff supply device 100, a shielding member 200, and a warmer 300 are installed adjacent to the heating cooker 10 of the heating cooking system 1. Note that a worktable for processing foodstuff after cooking can be installed as appropriate in the vicinity of the heating cooker 10, instead of the warmer 300 or in addition to the warmer 300.

The heating cooker 10 is a cooking device that cooks foodstuff by heating, and two heating cookers 10A and 10B are installed side by side in the present embodiment. The heating cookers 10A and 10B can be made up of devices that perform various types of heating cooking, and in the present embodiment, the heating cookers 10A and 10B are fryers that perform deep-frying cooking with cooking oil.

The heating cookers 10A and 10B heat lower faces of oil vats by heat sources such as gas burners or the like, for example. Exhaust gas (heated gasses) generated at this time passes over a rear face side (the side on which the shielding member 200, which will be described later, is installed) of the oil vats, and is exhausted from exhaust vents 11A and 11B formed at an upper portion of a rear face side of an enclosure of the heating cookers 10A and 10B.

Heat-shielding plates 12 and 13, for suppressing heat generated from the heat sources from being conveyed to the multi-joint robot 30, are installed in the heating cookers 10A and 10B.

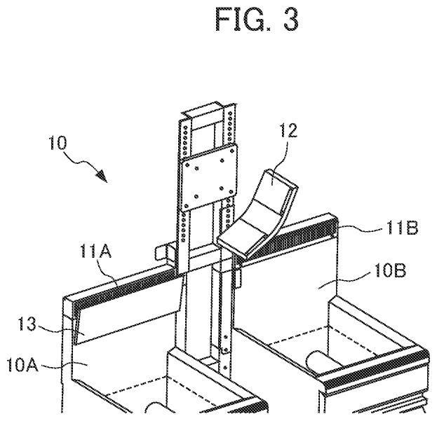

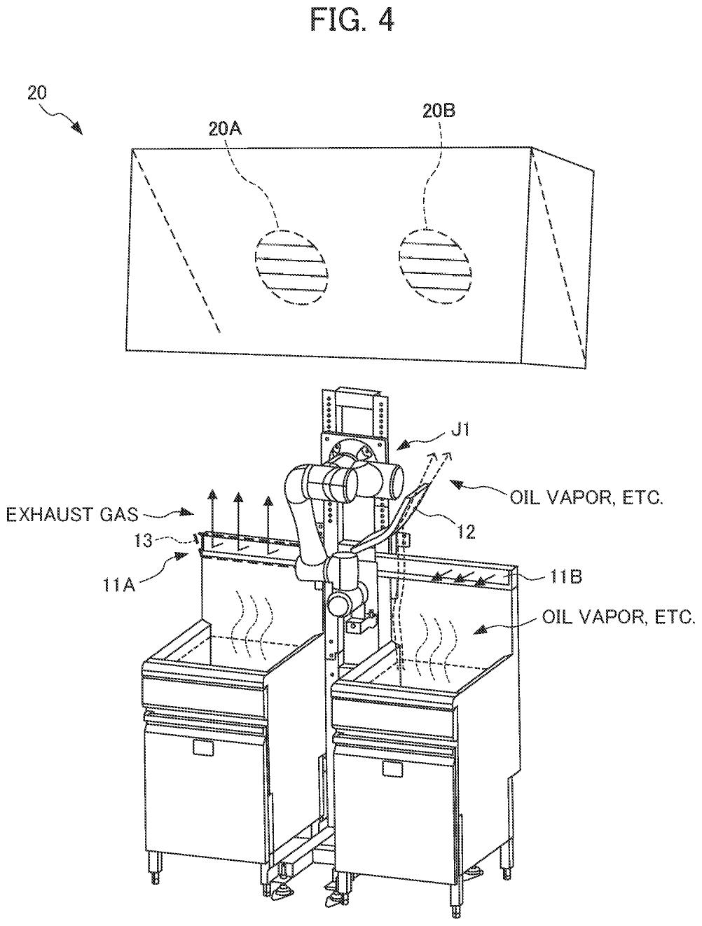

FIG. 3 is a schematic diagram illustrating a configuration example of the heat-shielding plates 12 and 13 installed in the heating cookers 10A and 10B. Also, FIG. 4 is a schematic diagram illustrating heat-shielding operations of the heat-shielding plates 12 and 13.

As illustrated in FIGS. 3 and 4, the heating cookers 10A and 10B are disposed side by side, with the multi-joint robot 30 being installed between the heating cookers 10A and 10B.

In the present embodiment, there are primarily two types of heat generated from the heating cookers 10A and 10B. One is heat from the exhaust gas from the exhaust vents 11A and 11B, and the other is heat from the surface of the heated oil in the oil vats of the heating cookers 10A and 10B (radiant heat and convection heat from oil vapor).

In the present embodiment, the heat-shielding plates 12 and 13 that suppress heat from being conveyed to the multi-joint robot 30 are installed in the heating cookers 10A and 10B, rather than implementing a method in which members are mounted to the multi-joint robot 30 or the like. In particular, the heat-shielding plates 12 and 13 are installed in forms that suppress heat from being conveyed from the heating cookers 10A and 10B to portions of the multi-joint robot 30 regarding which avoiding high-temperature situations is desirable (portions that are readily affected by heat, etc.). Examples of portions of the multi-joint robot 30 regarding which avoiding high-temperature situations is desirable include portions where motors that drive joints are installed, and each joint mechanism of the multi-joint robot 30. Note that portions of the multi-joint robot 30 regarding which avoiding high-temperature situations is desirable will be referred to as “heat-vulnerable portions 31” hereinafter.

The heat-shielding plates 12 and 13 can be made up of, for example, metal materials such as aluminum, stainless steel, and so forth, resin materials that have high heat resistance and oil resistance such as polycarbonate, polyether ether ketone resin, fluororesin, and so forth, and complexes thereof.

The heat-shielding plate 12 is installed between a first joint J1 of the multi-joint robot 30 (the joint closest to a fixation portion at which the multi-joint robot 30 is installed) and the oil vat (heat source) of the heating cooker 10B, and has a curved face that is convex outward as viewed from the multi-joint robot 30. Specifically, the heat-shielding plate 12 is installed at a position on an outer side of range of operations of members making up the first joint J1 in a case in which the first joint J1 of the multi-joint robot 30 turns, and has a curved face following turning operations of the members making up the first joint J1. Also, the curved face of the heat-shielding plate 12 is installed oriented such that the side thereof closer to a position between the heating cookers 10A and 10B (lower portion) assumes an angle close to horizontal, and such that the side thereof at a position closer to the middle of the oil vat of the heating cooker 10B (upper portion) assumes an angle close to vertical. Accordingly, the heat-shielding plate 12 is capable of shunting heat received from the heated oil in the oil vat of the heating cooker 10B upward (in a direction of the exhaust fans 20). Thus, a motor of the first joint J1 that is a heat-vulnerable portion 31 of the multi-joint robot 30 can be protected from the radiant heat from the surface of the heated oil in the oil vat of the heating cooker 10B, convection heat of the oil vapor, and so forth.

Note that in the present embodiment, the heating cooking system 1 is configured such that, with respect to the first joint J1 that is a heat-vulnerable portion 31 of the multi-joint robot 30, the heat-shielding plate 12 is installed on a side above the heating cooker 10B, and the heat-shielding plate 12 is not installed on a side above the heating cooker 10A. Accordingly, even in a case of a configuration in which the heat-vulnerable portion 31 is protected by the heat-shielding plate 12, the multi-joint robot 30 can be made to operate with a high degree of freedom without substantially restricting movement of the multi-joint robot 30. Which of both sides between which the heat-vulnerable portion 31 of the multi-joint robot 30 is interposed that the heat-shielding plate 12 is to be installed in can be decided in accordance with the size of the portion extending above the oil vat, the content of operations that are to be executed by the multi-joint robot 30 (e.g., over which oil vat the amount of time being positioned is longer in the programmed operations), and so forth.

The heat-shielding plate 13 is installed at the front of the exhaust vent 11A of the heating cooker 10A, with a predetermined distance (a distance such that exhaust gas from the exhaust vent 11A is not restricted) secured, and is installed as a member that suppresses exhaust gas (heated gasses) from blowing from the exhaust vent 11A (heat source) toward space above the oil vat of the heating cooker 10A (space in which the multi-joint robot 30 performs operations). The heat-shielding plate 13 can be made up of a member in a form of a substantially flat plate, for example, with a face thereof that faces the exhaust vent 11A of the heating cooker 10A inclined upward. That is to say, the heat-shielding plate 13 is installed inclined from a vertical direction such that the face thereof that faces the exhaust vent 11A of the heating cooker 10A is oriented somewhat upward (the normal extending from the face is oriented slightly upward from a horizontal direction). Note that due to the configuration in which the face that faces the exhaust vent 11A of the heating cooker 10A has an upward inclination, a configuration may be made in which the face of the heat-shielding plate 13 that faces the exhaust vent 11A of the heating cooker 10A has an inclination (i.e., a configuration in which a cross-section in a direction orthogonal to the longitudinal direction has a trapezoidal shape or the like).

Due to the heat-shielding plate 13 being installed, when the multi-joint robot 30 extends an arm thereof over the oil vat of the heating cooker 10A, a situation in which the exhaust gas (heated gasses) discharged from the exhaust vent 11A is blown onto the joint (heat-vulnerable portion 31) of the multi-joint robot 30 and members making up the joint are deformed or the like, can be suppressed.

Returning to the description of FIGS. 1 and 2, the exhaust fan 20 is an exhausting device that discharges exhaust gas (heated gasses) and oil vapor generated from the heating cooker 10 externally (outdoors, etc.). In the present embodiment, two exhaust fans 20A and 20B are installed upward (at a position higher from the ground) from each of the heating cookers 10A and 10B, respectively. Note that in a case of installing the exhaust fans 20A and 20B, a fan hood can be provided as appropriate, to collect the exhaust gas (heated gasses) and oil vapor.

The multi-joint robot 30 is made up of, for example, a six-axis vertical multi-joint robot or the like, and has a hand at a distal end of the robot arm that is capable of gripping a fry basket F. In the present embodiment, the multi-joint robot 30 is installed between the two heating cookers 10A and 10B. Accordingly, a relatively short length of reach necessary for the multi-joint robot 30 will suffice, and reduction in size and costs of the multi-joint robot 30 can be realized. Also, in comparison with a case in which the multi-joint robot 30 is installed to the front or the like of the heating cookers 10A and 10B, the heat generated from each of the heating cookers 10A and 10B can be made to be conveyed thereto less readily, and also the percentage of spattered cooking oil from the heating cookers 10A and 10B that reaches the multi-joint robot 30 can be suppressed.

Also, parts of the multi-joint robot 30 are heat-vulnerable portions 31 regarding which avoiding high-temperature situations is desirable. Examples of heat-vulnerable portions 31 include, as described above, portions where motors that drive joints are installed, and the join mechanisms of the multi-joint robot 30.

The heat-shielding plate 12 is installed at, of the heat-vulnerable portions 31 of the multi-joint robot 30, the vicinity of the first joint J1, and the radiant heat and convection heat from the heated oil in the oil vat of the heating cooker 10B are suppressed from being conveyed to the first joint J1.

Also, the heat-shielding plate 13 is installed, with respect to the joint mechanisms of the heat-vulnerable portions 31 of the multi-joint robot 30, at the front of the exhaust vent 11A of the heating cooker 10A, and heat from the exhaust gas from the exhaust vent 11A of the heating cooker 10A is suppressed from being conveyed to the joint mechanisms.

Also, the multi-joint robot 30 grips the fry basket F and transports the fry basket F to the foodstuff supply device 100, and accommodates therein foodstuff to be cooked by heating (frozen potatoes or the like) discharged from a foodstuff discharge opening of the foodstuff supply device 100. The multi-joint robot 30 then places the fry basket F accommodating the foodstuff in the cooking oil that is heated to an appropriate temperature by the heating cooker 10, and retrieves the fry basket F after a predetermined amount of time has elapsed. Thus, deep-frying cooking is performed using the multi-joint robot 30. Subsequently, the multi-joint robot 30 moves the foodstuff after cooking to the warmer 300 or the worktable while still in the fry basket F, which is then subjected to seasoning and to distribution at the warmer 300 or the worktable by another robot, a worker, or the like.

Note that the imaging device 60 installed by being fixed to a ceiling or the like, or the imaging device 60 installed on the distal end of the multi-joint robot 30, images the vicinity of the hand of the multi-joint robot 30, and the position of the fry basket F, positions of objects in the vicinity, and so forth, are recognized at all times in the processes of gripping the fry basket F, receiving supply of foodstuff, deep-frying cooking, and further transporting to the warmer 300 or the worktable.

The safety window 40 is a structure that partitions between a region in which work of cooking by heating is performed by the heating cooking system 1 (hereinafter referred to as “heating-cooking region”) and a region in which workers and so forth perform work, and come and go (hereinafter referred to as “worker region”). In the present embodiment, the safety window 40 is made up of a window frame, and a window material that is plate-like and that is made of a transparent material such as glass, resin, or the like. A lower end of the window frame of the safety window 40 is disposed at a position somewhat lower than an upper-face opening portion of a reservoir vat of cooking oil in the heating cooker 10, or approximately the same height. That is to say, a lower portion of the safety window 40 is an opening portion 40a, and the blower fan 50 is installed in this opening portion 40a. Note that in the present embodiment, a shielding member (sheet-like or plate-like member formed of transparent resin or the like) is installed extending upward from and in the right and left side direction of the window frame so as to surround the heating-cooking region. The shielding member at upward from the window frame extends to the fan hood of the exhaust fan 20, thereby suppressing exhaust gas (heated gasses) and oil vapor from flowing into the worker region from space above the window frame.

The blower fan 50 is installed in the opening portion 40a of the safety window 40, and blows air in the worker region toward the heating-cooking region.

The imaging device 60 is an imaging device that performs imaging of the range of operation of the heating cooking system 1 at predetermined time intervals (e.g., once a second), and can be made up of a digital camera, for example. In the present embodiment, a plurality of imaging devices 60 can be installed at necessary positions, so as to shoot the entire range of operation of the heating cooking system 1, and recognize the positions of various objects such as the fry basket F and so forth on the basis of the results of shooting, shoot the vicinity of the heating cooker 10 and recognize the state of cooking at the heating cooker 10 on the basis of the results of shooting, and so forth.

The control device 70 is made up of an information processing device such as a personal computer (PC), a programmable controller, or the like, and controls the overall heating cooking system 1 by executing various programs. For example, the control device 70 controls the operations of the multi-joint robot 30, operations of the foodstuff supply device 100, operations of the exhaust fan 20 and the blower fan 50, and so forth.

The foodstuff supply device 100 automatically supplies the foodstuff to be cooked by the heating cooking system 1. For example, the foodstuff supply device 100 discharges a predetermined amount of frozen potatoes or the like that are to be subjected to deep-frying cooking, from the foodstuff discharge opening, in accordance with operations performed by the control device 70 or a worker.

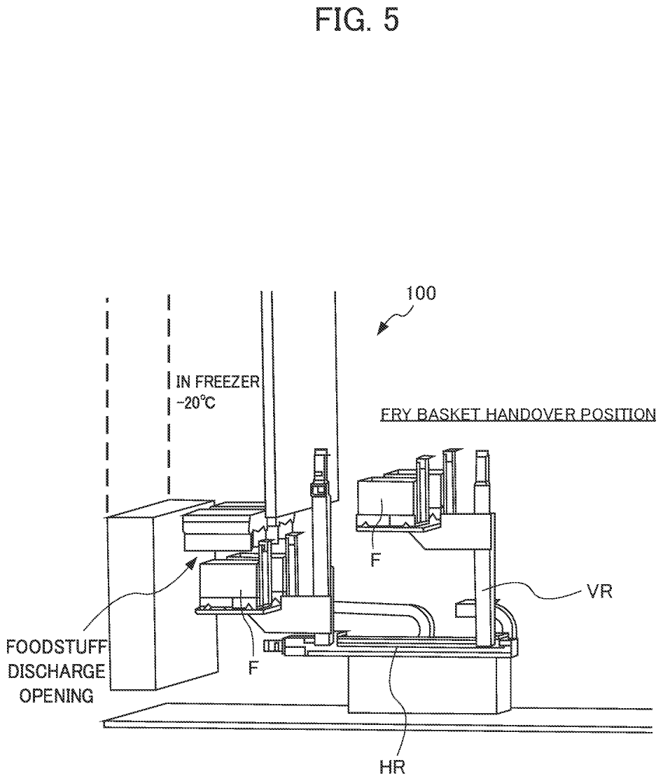

FIG. 5 is a schematic diagram illustrating a configuration of principal portions of the foodstuff supply device 100.

As illustrated in FIG. 5, the foodstuff supply device 100 has a configuration for dropping frozen foodstuff stored in a freezer (a storage chest maintained at approximately −20° C.), from the foodstuff discharge opening, so as to be supplied to the fry basket F set below the foodstuff discharge opening. The fry basket F is arranged to be capable of moving in the horizontal direction along a horizontal rail HR extending from below the foodstuff discharge opening along a side portion of the heating cooker 10A, and to be capable of moving in an up-down direction along a vertical rail VR extending vertically upward from a position at the side portion of the heating cooker 10A. The fry basket F is handed over between the multi-joint robot 30 and the foodstuff supply device 100 at a “fry basket handover position” that is set at an upmost portion of the vertical rail VR. Movement of the fry basket F in the vertical direction and the horizontal direction can be realized by various driving arrangements, and for example can use electric motors (not shown) that are installed for moving the fry basket F in each of the directions.

Note that in the present embodiment, the foodstuff discharge opening of the foodstuff supply device 100 is positioned downward in the vertical direction from opening portions of the oil vats of the heating cookers 10A and 10B. Accordingly, a configuration is made in which oil vapor that is generated at the surface of the heated oil in the oil vats of the heating cookers 10A and 10B does not readily enter into the foodstuff supply device 100.

The shielding member 200 is a member that surrounds part of a flow path of exhaust gas (heated gasses) and oil vapor from the heating cooker 10 to the exhaust fan 20, and in the present embodiment, the heating cooking system 1 is installed in contact with a wall, thereby causing the wall to function as the shielding member 200. Note, however, that in a case of installing the heating cooking system 1 at a position away from the wall, or the like, a shielding member 200 that is plate-like may be separately installed. Installing the shielding member 200 enables air blown by the blower fan 50 to be received by the shielding member 200, thereby suppressing airflow from leaking externally, and enabling effective exhaust to be performed by the exhaust fan 20.

The warmer 300 is a device for draining excess oil from the foodstuff after cooking by the heating cooking system 1, and also store the foodstuff in a heated state.

Hardware Configuration of Control Device 70

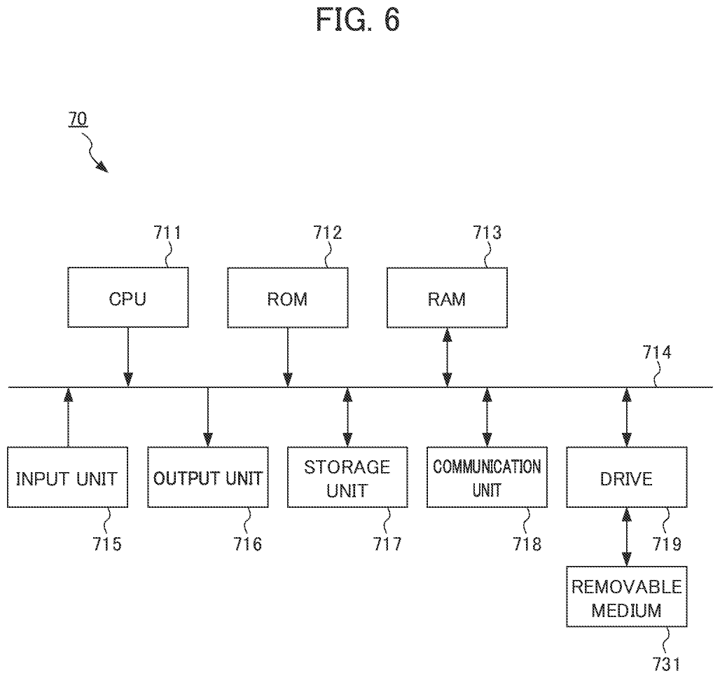

FIG. 6 is a schematic diagram illustrating a hardware configuration of the control device 70.

As illustrated in FIG. 4, the control device 40 includes a central processing unit (CPU) 711, read-only memory (ROM) 712, random-access memory (RAM) 713, a bus 714, an input unit 715, an output unit 716, a storage unit 717, a communication unit 718, and a drive 719.

The CPU 711 executes various types of processing following programs recorded in the ROM 712 or programs loaded to the RAM 713 from the storage unit 717.

The RAM 713 also stores data and so forth that is necessary for the CPU 711 to execute various types of processing, as appropriate.

The CPU 711, the ROM 712, and the RAM 713 are mutually connected via the bus 714. The input unit 715, the output unit 716, the storage unit 717, the communication unit 718, and the drive 719 are connected to the bus 714.

The input unit 715 includes an input device such as a mouse, a keyboard, or the like, and accepts input of various types of information directed to the control device 70. Note that a microphone may be included as the input unit 715, accepting input of various types of information by speech input by a worker.

The output unit 716 is made up of a display, a speaker, or the like, and outputs images or audio.

The storage unit 717 is made up of a hard disk, dynamic random-access memory (DRAM), or the like, and stores various types of data managed by various servers.

The communication unit 718 controls communication with other devices over a network.

A removable medium 731 such as a magnetic disk, an optical disc, a magneto-optical disk, semiconductor memory, or the like, is mounted to the drive 719 as appropriate. Programs read out from the removable medium 731 by the drive 719 are installed in the storage unit 717 as necessary.

Note that the above-described hardware configuration is a basic configuration of the control device 70, and that a configuration may be made in which part of the hardware is omitted, additional hardware is included, the form of implementation of the hardware is changed, or the like.

### [Functional Configuration]

Next, a functional configuration of the control device 70 will be described.

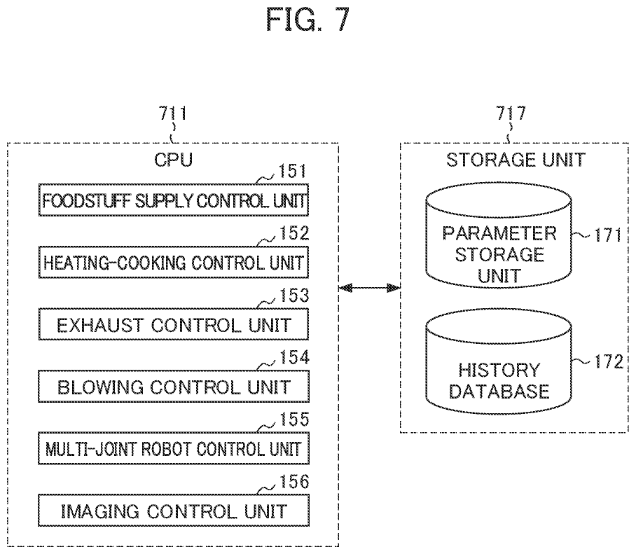

FIG. 7 is a block diagram illustrating the functional configuration of the control device 70.

As illustrated in FIG. 7, the CPU 711 of the control device 70 functions as a foodstuff supply control unit 151, a heating-cooking control unit 152, an exhaust control unit 153, a blowing control unit 154, a multi-joint robot control unit 155, and an imaging control unit 156, by executing a program for controlling operations of the heating cooking system 1. Also, a parameter storage unit 171 and a history database 172 are formed in the storage unit 717.

The parameter storage unit 171 stores various parameters used by the heating cooking system 1 when operating (e.g., heating temperature of the heating cooker 10 in accordance with the cooking, etc.).

The history database 172 stores parameters used at the time of various types of cooking being performed by the heating cooking system 1, and data of results of cooking foodstuff.

The foodstuff supply control unit 151 controls the foodstuff supply device 100, so as to cause the fry basket F to move along the horizontal rail HR or to move along the vertical rail VR. The foodstuff supply control unit 151 also causes a predetermined amount of foodstuff to be discharged from the foodstuff discharge opening in a case in which the fry basket F is in a standby state for receiving supply of the foodstuff (a state in which the fry basket F is standing by at the position below the foodstuff discharge opening).

The heating-cooking control unit 152 controls the heating cooker 10, and in a case in which cooking is performed by the heating cooking system 1, adjusts the heating temperature of the heating cooker 10.

The exhaust control unit 153 controls each of the exhaust fans 20A and 20B, and in a case in which cooking is performed by the heating cooking system 1, controls revolutions of each of the exhaust fans 20A and 20B.

The blowing control unit 154 controls the blower fan 50, and in a case in which cooking is performed by the heating cooking system 1, controls revolutions of the blower fan 50.

The multi-joint robot control unit 155 controls the operations of the multi-joint robot 30, and causes the multi-joint robot 30 to execute a series of operations that are defined in advance, in accordance with the type of cooking that is to be executed by the heating cooking system 1. For example, the multi-joint robot control unit 155 causes the multi-joint robot 30 to execute operations of gripping the fry basket F by the hand of the multi-joint robot 30, transporting the fry basket F, and placing the fry basket F in the heated cooking oil for a predetermined amount of time. In the present embodiment, the multi-joint robot control unit 155 is programmed such that when the multi-joint robot 30 grips and moves the fry basket F, the fry basket F does not interfere with the heat-shielding plate 12 in this operation. Specifically, the multi-joint robot control unit 155 rotates a wrist in a state of the hand of the multi-joint robot 30 gripping the fry basket F, and handles the fry basket F in a posture in which the fry basket F is facing inwards (in a posture in which the fry basket F is positioned closer to the arm side of the multi-joint robot 30 than the hand). Also, at this time, the multi-joint robot control unit 155 performs operations such as frying, oil draining, transporting, and so forth, while maintaining a state in which a reference point set regarding the fry basket F (e.g., an upper frame of a basket portion) is positioned downward in the vertical direction from the height of a lower end of the heat-shielding plate 12. Accordingly, even in a case in which the heat-shielding plate 12 is installed, operations can be performed in which the multi-joint robot 30 and the fry basket F do not interfere with the heat-shielding plate 12.

The imaging control unit 156 controls the imaging device 60, so as to shoot images of the overall range of operation of the heating cooking system 1 and images in the vicinity of the hand of the multi-joint robot 30 at predetermined time intervals.

### [Operations]

Next, operations of the heating cooking system 1 will be described.

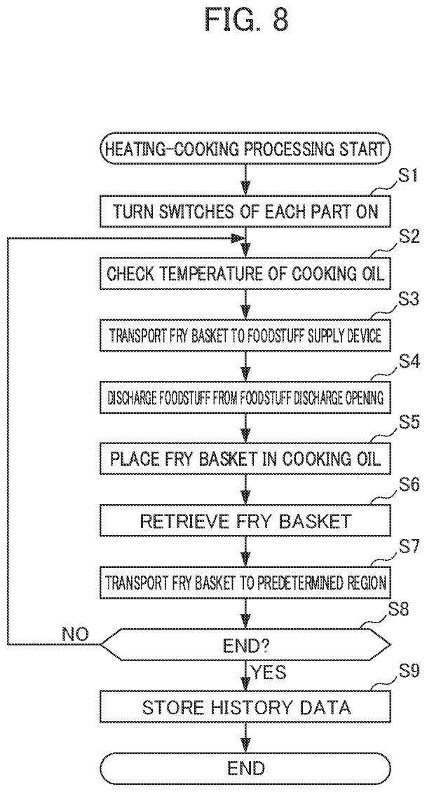

FIG. 8 is a flowchart illustrating the flow of heating-cooking processing executed by the heating cooking system 1.

When the heating-cooking processing is started, in step S1, the control device 70 turns the switches of the heating cooker 10, the exhaust fan 20, the multi-joint robot 30, and the blower fan 50 to on. Note that the power source of the foodstuff supply device 100 is always on, due to preserving foodstuff by freezing or the like.

In step S2, the heating-cooking control unit 152 confirms that the cooking oil in the heating cooker 10 has risen to a temperature suitable for cooking (e.g., 180° C.). The temperature of the cooking oil is constantly measured by a thermometer installed in the heating cooker 10.

As a result of the cooking oil being heated in the heating cooker 10, exhaust gas (heated gasses) is discharged from the exhaust vents 11A and 11B of the heating cookers 10A and 10B, and also radiant heat and oil vapor are generated at the surface of the heated oil. In the heating cooking system 1 according to the present embodiment, the heat-shielding plate 12 is installed between the first joint J1 of the multi-joint robot 30 and the oil vat of the heating cooker 10B, and accordingly heat is suppressed from being conveyed to the heat-vulnerable portion 31 (motor of the first joint J1) of the multi-joint robot 30.

In step S3, the multi-joint robot control unit 155 causes the multi-joint robot 30 to grip the fry basket F that is empty, and to be transported to the position of the foodstuff discharge opening of the foodstuff supply device 100.

In the present embodiment, in a case of the multi-joint robot 30 performing the operation of handing over the fry basket F to the foodstuff supply device 100, the joints of the multi-joint robot 30 will extend, and be positioned at a front portion of the exhaust vent 11A of the heating cooker 10A, as illustrated in FIG. 1. Accordingly, the exhaust gas from the exhaust vent 11A could be blown onto the joint mechanisms of the multi-joint robot 30, and a situation could occur in which heat is conveyed to the joint mechanisms. However, in the heating cooking system 1 according to the present embodiment, the heat-shielding plate 13 is installed at a front side of the exhaust vent 11A, and accordingly the direction of flow of the exhaust gas discharged from the exhaust vent 11A is changed by the heat-shielding plate 13 to advance toward the exhaust fan 20A above. As a result, the multi-joint robot 30 can be suppressed from being heated by exhaust gas from the exhaust vent 11A even in a case of handing over the fry basket F between the multi-joint robot 30 and the foodstuff supply device 100. There are cases in which exhaust gas from the exhaust vent 11A is exhausted at high-temperature states due to being exhaust gas from burning gas to heat the oil vat, and so forth, and accordingly the effects of shielding, in which the exhaust gas from the exhaust vent 11A is not blown onto the multi-joint robot 30 due to the heat-shielding plate 13, is extremely great.

In step S4, the foodstuff supply control unit 151 discharges a predetermined amount of foodstuff from the foodstuff discharge opening. The discharged foodstuff is accommodated in the fry basket F that is held by the multi-joint robot 30.

In step S5, the multi-joint robot control unit 155 controls the multi-joint robot 30 to place the fry basket F accommodating the foodstuff in the cooking oil of the heating cooker 10, and to execute deep-frying cooking.

In step S6, the multi-joint robot control unit 155 controls the multi-joint robot 30 to retrieve the fry basket F from the cooking oil of the heating cooker 10 after a predetermined amount of time (e.g., 3 minutes) has elapsed.

In step S7, the multi-joint robot control unit 155 controls the multi-joint robot 30 to transport the fry basket F accommodating the foodstuff after cooking to the predetermined region (the warmer 300, etc.) where downstream work is to be performed. The foodstuff that has been subjected to deep-frying cooking is thus handed over to the downstream work at the predetermined region.

In step S8, the multi-joint robot control unit 155 determines whether ending of cooking has been instructed.

In a case in which ending of cooking has not been instructed, determination of no is made in step S8, and the processing transitions to step S2.

On the other hand, in a case in which ending of cooking has been instructed, determination of yes is made in step S8, and the processing transitions to step S9.

In step S9, the multi-joint robot control unit 155 stores data of history indicating the series of operations in the heating-cooking processing in the history database 172. At this time, data of the results of cooking the foodstuff cooked by heating may be also stored in the history database 172 by manual input of a worker, or automatically from results of analyzing images shot by the imaging device 60.

After step S9, the heating-cooking processing ends.

Upon the heating-cooking processing ending, the multi-joint robot 30 returns to a standard posture, and also the switches of the heating cooker 10, the exhaust fan 20, the multi-joint robot 30, and the blower fan 50 are turned off.

Note that in the present embodiment, the two heating cookers 10A and 10B are provided as the heating cooker 10, and accordingly the above-described operations can be executed in parallel at the heating cookers 10A and 10B. In this case, when determining ending of cooking, the operations of the heating cooking system 1 are ended under a condition that ending of cooking has been instructed for both heating cookers 10A and 10B.

As described above, in the heating cooking system 1 according to the present embodiment, the heat-shielding plates 12 and 13 are installed in structures (wall, installed devices, etc.) other than the multi-joint robot 30, for the heat-vulnerable portions 31 of the multi-joint robot 30 that performs the work, and the heat-vulnerable portions 31 of the multi-joint robot 30 are protected from heat generated at the heat sources. Also, the heat-shielding plates 12 and 13 are installed at positions and forms that do not interfere with the multi-joint robot 30 at the time of the multi-joint robot 30 operating, and also so as to be capable of suppressing conveyance of heat to the heat-vulnerable portions 31.

Accordingly, the heating cooking system 1 according to the present embodiment can protect the heat-vulnerable portions 31 of the multi-joint robot 30 from heat, without obstructing the operations of the multi-joint robot 30.

That is to say, according to the present invention, heat that is conveyed from the heat sources to the robot can be suppressed more appropriately in facilities in which work is being performed using the robot.

### [Modification 1]

In the above-described embodiment, the configuration of the heat-shielding plate 12 may assume various forms as long as the portion thereof that extends above the oil vat of the heating cooker 10B is at an angle that is close to vertical.

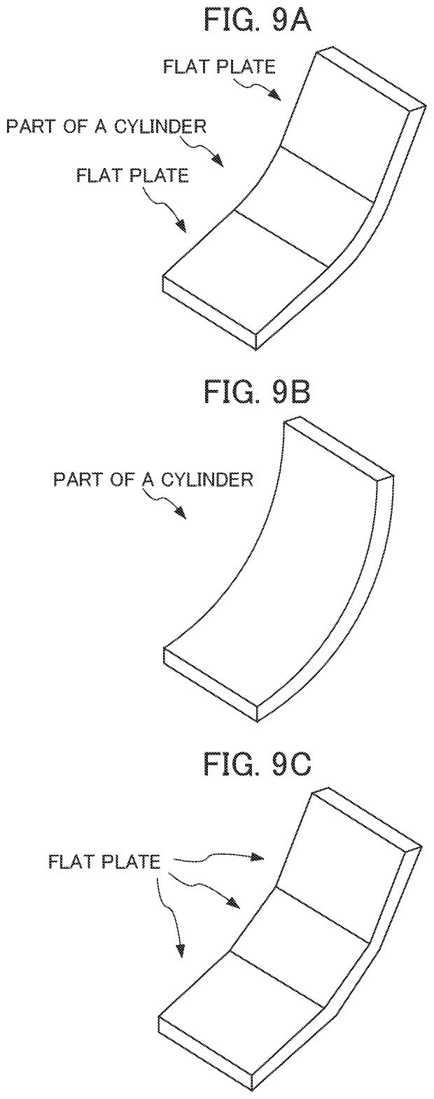

FIGS. 9A to 9C are schematic views illustrating specific configuration examples of the heat-shielding plate 12.

As illustrated in FIG. 9A, the heat-shielding plate 12 can be configured with a middle portion thereof being a part of a cylinder, and an upper portion and a lower portion thereof as flat places. In a case of such a configuration, the heat-shielding plate 12 can be fabricated by a simple method such as bending a flat plate at the middle, or the like.

Also, as illustrated in FIG. 9B, the heat-shielding plate 12 can be configured with the entirety thereof being part of a cylinder. In a case of such a configuration, the heat-shielding plate 12 can be installed at a position closer to the multi-joint robot 30 without impeding with operations of the multi-joint robot 30, by matching the center of the cylinder portion (the center axis of the cylinder) with the center of turning of the first joint J1 in the multi-joint robot 30, and matching the radius of the cylinder portion with the distance from the center of turning thereof.

Further, as illustrated in FIG. 9C, the heat-shielding plate 12 can be configured as a continuation of flat plates that are bent. In a case of such a configuration, the heat-shielding plate 12 can be fabricated by a simple method such as bending a flat plate at multiple positions, or the like.

### [Modification 2]

In the above-described embodiment, the heat-shielding plates 12 and 13 may each be made of different materials.

As described above, the heat-shielding plates 12 and 13 can be made up of metal materials such as aluminum, stainless steel, and so forth, resin materials that have high heat resistance and oil resistance such as polycarbonate, polyether ether ketone resin, fluororesin, and so forth, and complexes thereof, and the heat-shielding plate 12 and the heat-shielding plate 13 may each be made of different materials. Also, one face of each of the heat-shielding plate 12 and the heat-shielding plate 13 may be made of a different material from the other face thereof.

For example, an outer face of the heat-shielding plate 12 (a face toward the oil vat) may be made of a resin material that has higher oil resistance, and an inner face of the heat-shielding plate 12 (a face on the side of the multi-joint robot 30) may be made of a metal material. In this case, the heat-shielding plate 12 of which the outer face, which is subjected to oil vapor, has high oil resistance, may be fabricated by first working and shaping a metal base material, and thereafter forming a resin layer on the outer face.

Also, the face of the heat-shielding plate 13 facing the exhaust vent 11A of the heating cooker 10A (rear face) can be made of a resin material or a metal material with higher heat resistance, and the face toward the oil vat side of the heating cooker 10A (front face) can be made of a resin material that has higher oil resistance, for example. In this case, the heat-shielding plate 13 can be made such that the rear face subjected to the heated air that is hotter has high heat resistance, and the front face subjected to oil vapor has high oil resistance.

### [Modification 3]

Although description has been made in the above embodiment regarding a case in which the heat-shielding plate 12 is installed being fixed on one of the both sides between which the heat-vulnerable portion 31 of the multi-joint robot 30 is interposed, this is not limiting.

For example, a configuration may be made in which the heat-shielding plate 12 is movable around the heat-vulnerable portion 31 (first joint J1, etc.) of the multi-joint robot 30, such that the heat-shielding plate 12 can be installed at an appropriate side of the heat-vulnerable portion 31 of the multi-joint robot 30 in accordance with the contents of operation and so forth being executed by the multi-joint robot 30.

According to such a configuration, in a case of the multi-joint robot 30 performing various types of work, the heat-vulnerable portion 31 can be appropriately protected from heat in accordance with each type of work.

Although a configuration has been described in the above embodiment regarding the heating cooking system 1 having the two heating cookers 10A and 10B, this is not limiting.

For example, the present invention can be applied to a heating cooking system 1 having a single heating cooker 10.

Also, while an example has been described in the above embodiment and modifications regarding the heating cooking system 1 having the heating cooker 10 that performs deep-frying cooking, this is not limiting.

That is to say, the present invention is applicable to cases in which the heating cooker 10 performs cooking by boiling or cooking by frying, as well.

Also, while an example has been described in the above embodiment and modifications regarding a configuration that has the imaging device 60 that shoots the range of operation of the heating cooking system 1, with the control device 70 controlling the shooting by the imaging device 60, this is not limiting.

That is to say, a configuration may be made in which the predetermined operations of the multi-joint robot 30 are executed by positional control thereof, without shooting the range of operation of the heating cooking system 1 by an imaging device. In this case, the heating cooking system 1 will have a configuration including neither the imaging device 60 nor the imaging control unit 156.

Also, while an example has been described in the above embodiment and modifications regarding a configuration in which the control device 70 controls the heating cooker 10, the blower fan 50, and the exhaust fan 20, this is not limiting.

That is to say, the configuration may be altered to one in which a worker performs operations of the heating cooker 10, the blower fan 50, and the exhaust fan 20, as appropriate in accordance with the purpose of installation of the heating cooking system 1. In this case, the heating cooking system 1 will have a configuration not including the heating-cooking control unit 152, the exhaust control unit 153, and the blowing control unit 154. Also, the processing of controlling the heating cooker 10, the exhaust fan 20, and the blower fan 50 in step S1 in the heating-cooking processing, and the processing of measuring the temperature of the cooking oil in step S2, will not be executed.

Also, while an example has been described in the above embodiment and modifications regarding applying the present invention to a system of performing work of cooking, this is not limiting.

For example, the present invention can be applied to machining work such as cutting, welding, slicing, or the like, transportation work of goods, materials, and so forth, assembly work of machines, structures, and so forth, and so on.

As described above, the heating cooking system 1 according to the present embodiment includes the heating cooker 10, the heat-shielding plates 12 and 13, and the multi-joint robot 30.

The multi-joint robot 30 performs work.

The heating cooker 10 makes up a facility used for work.

The heat-shielding plates 12 and 13 are disposed at positions between a portion that is a heat source in an operating range of the multi-joint robot 30 in the facility, and a position of a heat-vulnerable portion 31 that is a part of the multi-joint robot 30 that is the object of heat-proofing measures, and are installed on structures other than the multi-joint robot 30.

Accordingly, the heat-vulnerable portions 31 of the multi-joint robot 30 can be protected from heat without obstructing operations of the multi-joint robot 30.

Thus, heat conveyed from a heat source to a robot in a facility where work is performed using the robot can be appropriately suppressed.

The heat-shielding plate 12 is installed between a heating-object portion (oil vat) of the heating cooker 10B where heating is performed in the facility, and the exhaust fan 20B that performs ventilation of the facility.

The portion of the heat-shielding plate 12 that extends between the heating-object portion and the exhaust fan 20B is installed in an orientation extending upward in the vertical direction.

Accordingly, a configuration can be realized in which the flow of heat generated at the heating-object portion is not impeded from being discharged from the exhaust fan 20B, even in a case of installing the heat-shielding plate 12.

The portion of the heat-shielding plate 12 that extends between the heating-object portion and the exhaust fan 20B shunts the heated air discharged from the heating cooker 10B to the operating range of the multi-joint robot 30, and the heat generated from the heating-object portion, along the portion thereof that extends upward vertically.

Accordingly, the heat-vulnerable portions 31 of the multi-joint robot 30 can be protected from the radiant heat from the surface of the heated oil in the oil vat of the heating cooker 10B, and the convection heat from the oil vapor.

The multi-joint robot 30 is installed adjacent to the heating cookers 10A and 10B.

The heat-shielding plate 12 is installed at, of the plurality of joints of the multi-joint robot 30, the vicinity of the first joint J1, which is the closest to the portion at which the multi-joint robot 30 is installed.

Accordingly, the motor of the first joint J1 that is the heat-vulnerable portion 31 of the multi-joint robot 30 can be protected from the radiant heat from the surface of the heated oil in the oil vat of the heating cooker 10B and the convection heat from the oil vapor.

The heat-shielding plate 13 is installed in front of the exhaust vent that discharges heated air from the heating cooker 10A, which performs heating in the facility, into the operating range of the multi-joint robot 30.

Accordingly, the heated air discharged from the exhaust vent can be suppressed from being blown onto the joints that are the heat-vulnerable portions 31 of the multi-joint robot 30.

The normal of the heat-shielding plate 13 that extends from the face thereof facing the exhaust vent is oriented upward from the horizontal direction.

Accordingly, a configuration can be made in which the flow of heated air discharged from the exhaust vent is not impeded even in a case in which the heat-shielding plate 13 is installed.

In a case in which the arm is extended for handing over a work object, at least part of the arm of the multi-joint robot 30 is held in a posture of being stopped in front of the exhaust vent.

A second heat-shielding member changes the direction of flow of heated air discharged from the exhaust vent in a direction toward the arm that is stopped, so as to be directed upwards by the inclined face that faces the exhaust vent.

Accordingly, even in a process in which the multi-joint robot 30 is stopped for a relatively long time, and can be continuously subjected to heat, a situation can be suppressed from occurring in which the heated air discharged from the exhaust vent is blown on the joints, which are the heat-vulnerable portions 31 of the multi-joint robot 30, and the members making up the joints being affected by the heat.

The multi-joint robot 30 performs work while maintaining a state in which the height of a predetermined portion of the object being gripped is positioned lower in the vertical direction than the height of the lower end of the heat-shielding plate 12.

Accordingly, even in a case in which the heat-shielding plate 12 is installed, operations can be performed in which the multi-joint robot 30 and the fry basket F do not interfere with the heat-shielding plate 12.

Note that the above-described embodiments and modifications are examples of embodiments of the present invention, and various embodiments that realize the functions of the present invention are encompassed by the scope of the present invention.

The present invention can be carried out combining examples described in the above embodiment as appropriate.

The processing sequence described above can be executed by hardware, and can also be executed by software.

In other words, the functional configuration in FIG. 7 is only exemplary, and is not limiting in particular. That is to say, it is sufficient for the heating cooking system 1 to be provided with functions that enable the overall processing sequence described above to be executed, and what sort of function blocks to use for realizing these functions is not limited to the example in FIG. 7.

A single functional block may be configured by a single piece of hardware, a single installation of software, or a combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium storing the program is made up of removable media that is distributed separately from the apparatus main unit, or storage media or the like that is built into the apparatus main unit in advance. Examples of the removable media include magnetic disks, optical discs, magnetooptical disks, flash memory, and so forth. Examples of optical disks include compact disc read-only memory (CD-ROM), Digital Versatile Discs (DVD), Blu-ray discs (registered trademark), and so forth. Examples of magnetooptical disks include MiniDiscs (MD) and so forth. Examples of flash memory include Universal Serial Bus (USB) memory and Secure Digital (SD) cards. Also, examples of storage media built into the apparatus main unit in advance include ROM, hard disks, and so forth, in which programs are stored.

It should be noted that, in the present specification, the steps describing the program recorded in the storage medium include not only the processing executed in a time series following this order, but also processing executed in parallel or individually, which is not necessarily executed in a time series.

Further, in the present specification, the terminology of the system means an entire apparatus including a plurality of apparatuses and a plurality of units.

The above embodiment is an example to which the present invention is applied, and does not limit the technical scope of the present invention. That is, the present invention may be subjected to various modifications such as omission and replacement without deviating from the spirit of thereof, and various embodiments other than that described above may be implemented. Various embodiments and modifications thereof that can be implemented in the present invention are included in the scope of the invention described in the claims and an equivalent scope.

What is claimed is:

1. A work system, comprising:
a robot that performs work;
a facility used for the work; and
a heat-shielding member that is installed on a structure other than the robot, and is disposed between a portion that is a heat source in an operating range of the robot in the facility, and a position of a heat-vulnerable portion in the robot that is an object part of heat-proofing measures.

2. The work system according to claim 1, wherein
the heat-shielding member includes a first heat-shielding member that is installed between a heating-object portion of a heating device that performs heating in the facility, and an exhaust device that performs ventilation of the facility, and
a portion of the first heat-shielding member that extends between the heating-object portion and the exhaust device is installed at an orientation extending vertically upward.

3. The work system according to claim 2, wherein
the portion of the first heat-shielding member that extends between the heating-object portion and the exhaust device shunts heated air discharged from the heating device to the operating rang of the robot, and heat generated from the heating object portion, along the portion extending vertically upward.

4. The work system according to claim 2, wherein
the robot is installed adjacent to the heating device, and
the first heat-shielding member is installed in a vicinity of a first joint that is closest to a portion at which the robot is installed, out of a plurality of joints included in the robot.

5. The work system according to claim 1, wherein
the heat-shielding member includes a second heat-shielding member that is installed in front of an exhaust vent that discharges heated air from the heating device that performs heating in the facility to the operating range of the robot.

6. The work system according to claim 5, wherein
a normal extending from a face of the second heat-shielding member that faces the exhaust vent is oriented upward from a horizontal direction.

7. The work system according to claim 6, wherein
in a case in which an arm of the robot is extended for handing over a work object, at least part of the arm is held in a posture of being stopped in front of the exhaust vent, and
the second heat-shielding member changes a direction of flow of heated air that is discharged from the exhaust vent toward the arm that is stopped upwards, by the face thereof that faces the exhaust vent and that is inclined.

8. The work system according to claim 1, wherein
the robot performs the work while maintaining a state in which a height of a predetermined portion of an object that is gripped is positioned lower in a vertical direction than a height of a lower end of the heat-shielding member.
